(19) United States
(12) Patent Application Publication
(10) Pub. No.: US 2009/0289828 A1
(43) Pub. Date: Nov. 26, 2009

(54) Wireless transferable control system

(76) Inventor: John Alfred Hinchey, Manchester, NH (US)

Correspondence Address: John Alfred Hinchey, 132 Glen Bloom Dr., Manchester, NH, 03109, US

(21) Appl. No.: 12/154,332

(22) Filed: May 22, 2008

(51) Int. Cl. H04L 17/02

(52) U.S. Cl. 341/176

(57) ABSTRACT

It is desirable for operators of remote control systems to share the experience of controlling remote devices or appliances with others. To accomplish this, a system has evolved whereby a Slave transmitter is cable connected to a Master transmitter and a Master/Slave Switch is added to the Master transmitter enabling control to be transferred back and forth between the transmitters. The present invention replaces the hard-wired connection with a wireless facility consisting of a discrete or segmented programmable Slave Receiver and Adaptive Director Firmware Module that provides the desired functionality wirelessly and also provides significant case-of-use and compatibility features currently unavailable. By replacing the hard-wired connection with a wireless connection, a receiver that can accept and demodulate the wireless transmission, and adaptive programmable firmware (hardware and software) the present invention provides the desired transferability of control readily and conveniently without the limitations or constraints of the current art.

### FIELD OF THE INVENTION

The invention relates generally to remote control systems for model boats, airplanes, gliders, helicopters, cars and other appliances and, more particularly, to a wireless system enabling selectable manipulation and operation of the remote vehicle or appliance by two or more controllers.

### BACKGROUND OF THE INVENTION

An instrument, mobile vehicle, or other appliance can be remotely controlled by operating controls on a transmitting device which encode these operations into electrical signals and transmit them through a wired or wireless communications link. An appropriate receiver decodes the transmitted stream and directs suitable actuators to propel, and/or steer, and/or otherwise manipulate the remote device or appliance. Typically the communications link between the Master, or primary, Transmitter, and the remote receiver device consists of a modulated carrier wave. The carrier wave may function in any band within any spectrum including, but not limited to, sub-sonic, sonic, supersonic, infrared, light, radio or ultra radio frequencies. Remote controlled model airplanes, cars, helicopters and boats have developed a large following among the public. Remote controlled models typically include several servo controlled systems such as throttles, rudders, ailerons, brakes and similar systems which allow control over speed and direction of the vehicle or appliance by the application of control signals. Typically these signals are generated by a hand held controller as determined by the manual positioning of control sticks, levers and switches on the controller. While such controllers could be hardwired to the model, maximum freedom in maneuverability and the possibility of interaction between different hobbyists is achieved using wireless communication between the handheld controller and receiver/servo/actuator circuitry on the model. In this case circuitry within the controller continuously encodes the manual control stick, lever and switch positions into a representative composite signal, modulates and/or multiplexes the signal onto an acoustic, infrared, light, radio or microwave carrier wave, and radiates it to a remote receiver over a Primary Communications Link. The remote receiver captures the transmitted signal, de-modulates and/or de-multiplexes it and generates separate and distinct control signals to one or more servos or actuators. The servos or actuators convert the signals to physical movement or action thus directing the remote vehicle or appliance as intended.

To share the experience and to aid in the training of other operators a method has evolved whereby control of the remote device is transferable to a second transmitter—the Slave, or trainer or secondary, Transmitter—which is physically connected by one or more pairs of wire to the Master, or primary, Transmitter. Conventionally this is done on an as desired basis—a cable, specially designed for specific manufactures' transmitters, is plugged into the Master, or primary, Transmitter and the other end is plugged into the Slave, or secondary, Transmitter. The Slave, or secondary, Transmitter delivers a signal stream representing the positions of its control sticks, levers and switches. A Master/Slave Switch on the Master, or primary, Transmitter enables its operator to select which stream, the one generated within the Master, or primary, Transmitter or the one generated within the Slave, or secondary, Transmitter, modulates and/or multiplexes the Master, or primary, Transmitter's signal for transmission over the Primary Communications Link. In this way, the remote vehicle or appliance follows the designations of the Master, or primary, Transmitter operator when the switch is in the ‘Master’ position and follows the designations of the Slave, or secondary, Transmitter operator when the switch is in the ‘Slave’ position. By this means, control of the remote vehicle or appliance is transferable to either the Master, or primary, Transmitter's operator or the Slave, or secondary, Transmitter's operator. This arrangement is often referred to as a ‘buddy-box’ setup.

### SUMMARY OF THE INVENTION

The present invention supplants the current art requiring a wired connection between the Master, or primary, Transmitter and the Slave, or secondary, Transmitter with an innovative wireless Slave-To-Master Communications facility and Adaptive programmable hardware and software, or Firmware.

The Slave-To-Master Communications facility and Adaptive Firmware of the present invention providing wireless interconnection between the Slave, or secondary, Transmitter and the Master, or primary, Transmitter may be manifested in many variations and configurations of encoding, modulating, multiplexing, decoding, demodulating, and de-multiplexing utilizing acoustic, infrared light spectrum, ultraviolet light spectrum, visible light spectrum, and/or electromagnetic spectrum carrier waves.

The present invention consists of a programmable Slave Receiver and Adaptive Director Firmware Module, that may be instantiated as an integrated unit or segmented into a Slave, or secondary, Transmitter Signal Receiver sub-module and an Adaptive Director Firmware sub-module, which processes radiated signals emitted from a Slave, or secondary, Transmitter and propagated over a Slave-To-Master Communications Link. The Slave Receiver and Adaptive Director Firmware Module instantiated as an integrated unit or segmented into a Slave, or secondary, Transmitter Signal Receiver sub-module and an Adaptive Director Firmware sub-module may be integrated into, or attached to, a Master, or primary, Transmitter or may be implemented with a Slave, or secondary, Transmitter Signal Receiver sub-module integrated into, or attached to a Master, or primary, Transmitter and an Adaptive Director Firmware sub-module integrated into or attached to a Slave, or secondary, Transmitter. The Slave Receiver and Adaptive Director Firmware Module, for integrated implementations, or the Slave, or secondary, Transmitter Signal Receiver sub-module and the Adaptive Director Firmware sub-module for segmented implementations, captures and conditions signals delivered over a Slave-To-Master Communications Link and presents the conditioned bit stream to one side of the Master, or primary, Transmitter's Master/Slave Switch. The Master, or primary, Transmitter's bit stream is connected to the other side of the Master, or primary, Transmitter's Master/Slave Switch. In operation the Master, or primary, Transmitter establishes communication with the remote receiver over a Primary Communications Link with the Master/Slave Switch of the present invention in the ‘Master’ position. This is the normal or default position and the operator of the Master, or primary, Transmitter controls the remote device or appliance. At anytime the Slave, or secondary, Transmitter may be turned on and radiates its signal, containing the encoded representation of the Slave, or secondary, Transmitter's control sticks, levers and switches, over the Slave-To-Master Communications Link. Now, with the Master, or primary, Transmitter and the Slave, or secondary, Transmitter powered on, whenever the Master/Slave Switch is placed into the ‘Slave’ position the radiated signal from the Master, or primary, Transmitter will contain the encoded representations of the Slave, or secondary, Transmitter's control sticks, levers and switches as captured and conditioned by the Slave-To-Master Communications facility and the Adaptive Firmware of the present invention. In this way the present invention enables the remote device or appliance to be controlled by the operator of the Slave, or secondary, Transmitter. Returning the Master/Slave Switch of the present invention to the ‘Master’ positions transfers control of the remote device or appliance back to the operator of the Master, or primary, Transmitter.

It is an object of the present invention to provide a wireless Slave-To-Master Communications Facility alternative to the current art requiring a hard wired interconnection between a Master, or primary, Transmitter and a Slave, or secondary, Transmitter for the purpose of transferring control of remote devices and/or appliances to trainee or guest operators.

It is an object of the present invention to significantly enhance the ease-of-use and convenience of transferring control of remote devices or appliances to trainees or guests by Master, or primary, Transmitter operators.

It is an object of the present invention to significantly improve the versatility of a facility for transferring control of remote devices or appliances to trainees or guests by Master, or primary, Transmitter operators. The present invention can be embodied to accommodate diverse base methods of coding, modulating, and/or multiplexing the conversion of control sticks, levers and switches positions into electrical signals and the decoding, demodulating, and/or de-multiplexing functions of de-conversion to effect remote device or appliance actions.

It is an object of the present invention to provide a wireless Slave-To-Master Communications Facility alternative to the current art requiring a hard wired interconnection between a Master, or primary, Transmitter and a Slave, or secondary, Transmitter for the purpose of transferring control of remote devices or appliances to trainees or guests and which functions independent of Master, or primary, Transmitter radiation mode or carrier wave frequency. That is, the present invention is adaptive providing full Master/Slave functionality in systems utilizing radiation methods including, but not limited to:
Amplitude Modulation on sub-sonic, sonic, infrared, radio, microwave, short wave, or ultra short wave fixed or spread spectrum carrier frequencies.
Frequency Modulation on sub-sonic, sonic, infrared light, ultraviolet light, visible light, radio, microwave, short wave, or ultra short wave fixed or spread spectrum carrier frequencies.
   both base-band and side-band.

It is an object of the present invention to provide a wireless Slave-To-Master Communications Facility alternative to the current art requiring a hard wired interconnection between a Master, or primary, Transmitter and a Slave, or secondary, Transmitter for the purpose of transferring control of remote devices or appliances to trainees or guests and which functions independent of Master, or primary, Transmitter encoding, modulating and/or multiplexing modes. That is, the present invention is adaptive providing full Master/Slave functionality in systems utilizing encoding, modulating and/or multiplexing methods including, but not limited to:
Pulse Code Modulation
Pulse Position Modulation

It is an object of the present invention to provide a wireless Slave-To-Master Communications Facility alternative to the current art requiring a hard wired interconnection between a Master, or primary, Transmitter and a Slave, or secondary, Transmitter for the purpose of transferring control of remote devices or appliances to trainees or guests and which functions independent of Slave, or secondary, Transmitter encoding, modulating and/or multiplexing modes or carrier wave frequency.

Broadly stated, the present invention is an apparatus comprising a programmable Slave Receiver and Adaptive Director Firmware Module, that may be instantiated as an integrated unit or segmented into a Slave, or secondary, Transmitter Signal Receiver sub-module and an Adaptive Director Firmware sub-module, which processes radiated signals emitted from a Slave, or secondary, Transmitter and propagated over a Slave-To-Master Communications Link. The Slave Receiver and Adaptive Director Firmware Module instantiated as an integrated unit or segmented into a Slave, or secondary, Transmitter Signal Receiver sub-module and an Adaptive Director Firmware sub-module may be integrated into, or attached to, a Master, or primary, Transmitter or may be implemented with a Slave, or secondary, Transmitter Signal Receiver sub-module integrated into, or attached to a Master, or primary, Transmitter and an Adaptive Director Firmware sub-module integrated into or attached to a Slave, or secondary, Transmitter. The Slave Receiver and Adaptive Director Firmware Module, for integrated implementations, or the Slave, or secondary, Transmitter Signal Receiver sub-module and the Adaptive Director Firmware sub-module for segmented implementations, processes and conditions signals delivered over a Slave-To-Master Communications Link and presents a conditioned bit stream to one side of the Master, or primary, Transmitter's Master/Slave Switch. The Master, or primary, Transmitter's bit stream is connected to the other side of the Master, or primary, Transmitter's Master/Slave Switch. When set in the ‘Master’ position The Master, or primary, Transmitter's bit stream is delivered to the Master, or primary, Transmitter's modulator. When set in the ‘Slave’ position, the conditioned bit stream provided from the Slave Receiver and Adaptive Director Firmware Module, for integrated implementations, or from either the Slave, or secondary, Transmitter Signal Receiver sub-module or Adaptive Director Firmware sub-module, for segmented implementations of the present invention is delivered to the Master, or primary, Transmitter's modulator. In either case the Master, or primary, Transmitter transmits the modulated signal over a Primary Communications Link.

### BRIEF DESCRIPTION OF THE DRAWINGS

The same numbers are used throughout the drawings to reference like features and components.

FIG. 1 is a front view of a representative embodiment of the present invention.

FIG. 2 is a front view of an alternative representative embodiment of the present invention.

FIG. 3 is a generalized block diagram of the Slave Receiver and Adaptive Director Firmware for a representative embodiment of the present invention.

FIG. 4 is a flow chart of the operation of the Slave Receiver and Adaptive Director Firmware for a representative embodiment of the present invention.

FIG. 5 is a generalized block diagram illustrating one method for how the Adaptive Director Firmware for either the Slave Receiver and Adaptive Director Firmware Module, for integrated unit implementations, or for the Adaptive Director Firmware submodule, for segmented implementations, of a representative embodiment of the present may be programmed to suit varying environments.

FIG. 6 is a front view of a second alternative representative embodiment of the present invention with provision to dynamically alter the operation of the Slave Receiver and Adaptive Director Firmware Module.

FIG. 7 is a front view of a third alternative representative embodiment of the present invention.

### DETAILED DESCRIPTION OF THE PREFERRED EMBODIMENTS

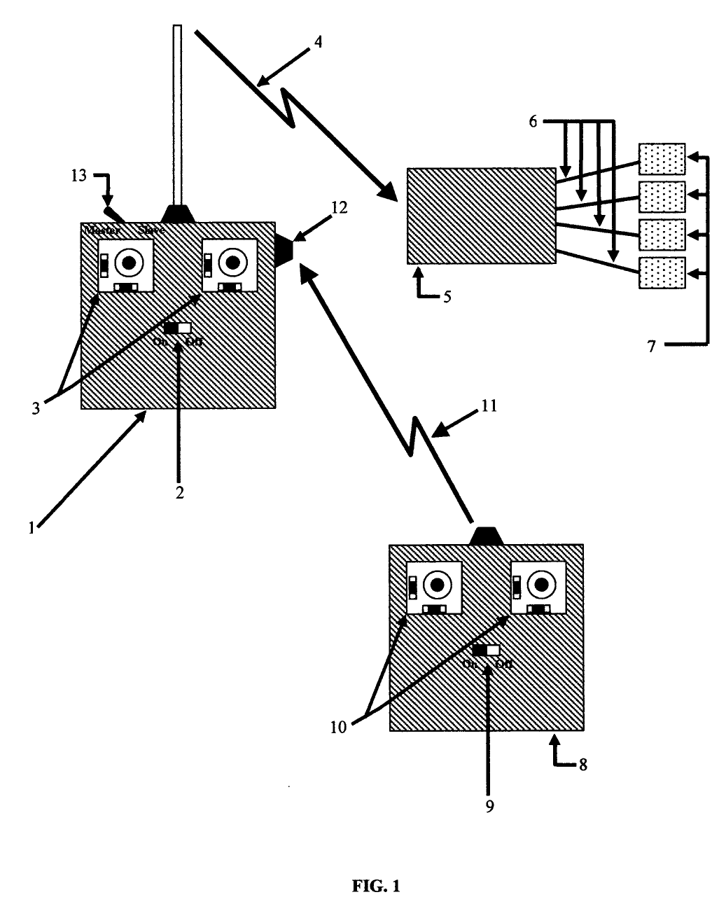

Referring to FIG. 1 a representative embodiment of the present invention is illustrated. In FIG. 1 there is shown a front view of a representative embodiment of the present invention having a Master, or primary, Transmitter 1, Master, or primary, Transmitter Power Switch 2, Master Control Sticks, Levers and Switches 3, a Primary Communications Link 4, a Primary Receiver 5, a series of De-multiplexed/Decoded Control Signals 6, a series of Vehicle/Appliance Actuators 7, a Slave, or secondary, Transmitter 8, a Slave, or secondary, Transmitter Power Switch 9, Slave Control Sticks, Levers and Switches 10, a Slave-To-Master Communications Link 11, a Slave Receiver and Adaptive Director Firmware Module 12 attached to the Master, or primary, Transmitter 1, and a Master/Slave Switch 13.

Still referring to the representative embodiment of the present invention illustrated in FIG. 1, both the Master, or primary, Transmitter 1 and the Slave, or secondary, Transmitter 8 are powered on as the Master, or primary, Transmitter Power Switch 2 is in the ‘On’ position as is the Slave, or secondary, Transmitter Power Switch 9. As the Master/Slave Switch 13 is in the ‘Master’ position the Master, or primary, Transmitter 1 is radiating the coded signal representations of the Master Control Sticks, Levers and Switches 3 over the Primary Communications Link 4, and are being received and processed by the Primary Receiver 5 which decodes the composite received signal and separates it into distinct De-multiplexed/Decoded Control Signals 6 which are interpreted and executed by the Vehicle/Appliance Actuators 7 thereby imparting the Master, or primary, Transmitter 1 operator's directives into remote device or appliance actions.

In more detail, still referring to the representative embodiment of the present invention of FIG. 1, the signal transmitted over the wireless Slave-to-Master Communications Link 11 is received by the Slave Receiver and Adaptive Director Firmware Module 12 attached to the Master, or primary, Transmitter 1 but is providing no influence over the signal transmitted by the Master, or primary, Transmitter 1 as the Master/Slave Switch 13 is in the ‘Master’ position and the Master, or primary, Transmitter's bit stream is flowing directly to the Master, or primary, Transmitter's 1 Modulator. When, however, the Master/Slave Switch 13 is placed in the ‘Slave’ position the Slave Receiver and Adaptive Director Firmware Module 12 receives and processes the wireless signal arriving over the Slave-to-Master Communications Link 11 and the resultant bit stream is delivered to the Master, or primary, Transmitter's 1 Modulator. In either case, i.e. when the Master/Slave Switch 13 is in the ‘Master’ position or in the ‘Slave’ position, the Master, or primary, Transmitter 1 propagates the bit stream provided to its modulator over the Primary Communications Link 4.

Still referring to the representative embodiment of the present invention of FIG. 1 the processing and conditioning of the signal arriving over the Slave-to-Master Communications Link 11 by the Slave Receiver and Adaptive Director Firmware Module 12 is governed by logic embedded in the Slave Receiver and Adaptive Director Firmware Module 12 which condition the bit stream it receives according to parameters also embedded within the Slave Receiver and Adaptive Director Firmware Module 12 and/or switches/jumpers attached to the Slave Receiver and Adaptive Director Firmware Module 12. By this means, control of the Vehicle/Appliance Actuators 7 can be transparently transferred to the operator of the Slave, or secondary, Transmitter 8 operator independent of transmission or signal encoding schemes employed by either the Master, or primary, Transmitter 1 or the Slave, or secondary, Transmitter 8.

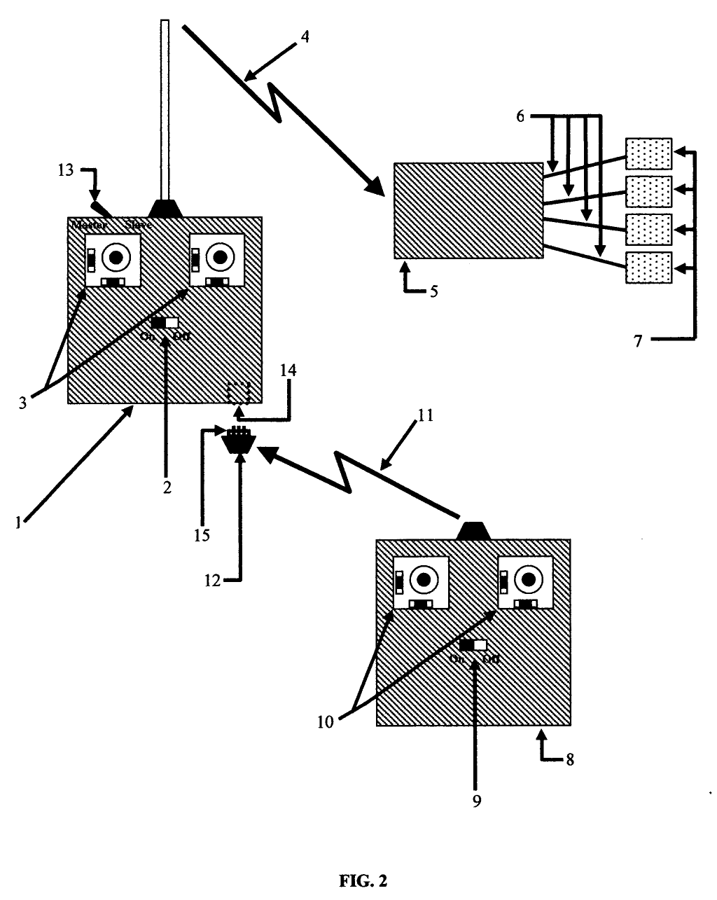

Referring now to FIG. 2 a front view of a first alternate embodiment of the present invention is illustrated having a Master, or primary, Transmitter 1, Master, or primary, Transmitter Power Switch 2, Master Control Sticks, Levers and Switches 3, a Primary Communications Link 4, a Primary Receiver 5, a series of De-multiplexed/Decoded Control Signals 6, a series of Vehicle/Appliance Actuators 7, a Slave, or secondary, Transmitter 8, a Slave, or secondary, Transmitter Power Switch 9, Slave Control Sticks, Levers and Switches 10, a Slave-To-Master Communications Link 11, a Slave Receiver and Adaptive Director Firmware Module 12, a Conventional ‘Buddy Box’ Socket Compatible Plug 15 affixed to the Slave Receiver and Adaptive Director Firmware Module 12 and a Master/Slave Switch 13. In this instance the Master, or primary, Transmitter 1 is configured with a Conventional ‘Buddy Box’ Socket 14 usable to plug in one end of the conventional Slave, or secondary, Transmitter to Master, or primary, Transmitter hard wired connection. In this first alternate embodiment of the present invention the Slave Receiver and Adaptive Director Firmware Module 12 is extended with a Conventional ‘Buddy Box’ Socket Compatible Plug 15 thereby providing a direct wireless replacement for the Conventional ‘Buddy Box’ hard wired connection. By this means the functionality of the present invention is extended to existing varieties of Master, or primary, Transmitters 1 already in service which have a Conventional ‘Buddy Box’ Socket 14. This first alternate embodiment of the present invention illustrated in FIG. 2 is a wireless one-for-one replacement for the Conventional ‘Buddy Box’ hard wired connection system of sharing control of remote devices and appliances. The Slave Receiver and Adaptive Director Firmware Module 12 of this first alternate embodiment of the present invention receives, demodulates, and conditions the signal arriving on the Slave-To-Master Communications Link 11 and makes it available to the Master, or primary, Transmitter 1. Various Conventional ‘Buddy Box’ Socket 14 configurations are produced by the major manufactures of remote control systems and each may be readily accommodated by a correspondingly tailored Conventional ‘Buddy Box’ Socket Compatible Plug 15.

In more detail, still referring first alternate embodiment of the present invention of FIG. 2, Transmitter 1 is delivering the Master, or primary, Transmitter's bit stream directly to the Master, or primary, Transmitter's 1 Modulator. The Slave Receiver and Adaptive Director Firmware Module 12 is plugged into Transmitter's 1 by means of the attached Conventional ‘Buddy Box’ Socket Compatible Plug 15 and the signal transmitted over the wireless Slave-to-Master Communications Link 11 is received and conditioned by the Slave Receiver and Adaptive Director Firmware Module 12 attached to the Master, or primary, Transmitter 1 but is providing no influence over the signal transmitted by the Master as the Master/Slave Switch 13 is in the ‘Master’ position. When, however, the Master/Slave Switch 13 is placed in the ‘Slave’ position the Slave Receiver and Adaptive Director Firmware Module 12 receives and processes the wireless signal arriving over the Slave-to-Master Communications Link 11 and delivers the resultant bit stream to the Master, or primary, Transmitter's 1 Modulator. In either case, i.e. whether the Master/Slave Switch 13 is in the ‘Master’ position or in the ‘Slave’ position, the Master, or primary, Transmitter 1 propagates the bit stream provided to its modulator over the Primary Communications Link 4. This first alternate embodiment of the present invention of FIG. 2 provides wireless functionality equivalent to the Conventional ‘Buddy Box’ hard-wired system of instantiating transferable control of a remote vehicle or appliance.

Still referring to the first alternate embodiment of the present invention of FIG. 2, the processing and conditioning of the signal arriving over the Slave-to-Master Communications Link 11 by the Slave Receiver and Adaptive Director Firmware Module 12 is governed by logic embedded in the Slave Receiver and Adaptive Director Firmware Module 12 which condition the bit stream it receives according to parameters also embedded within the Slave Receiver and Adaptive Director Firmware Module 12 and/or switches/jumpers attached to the Slave Receiver and Adaptive Director Firmware Module 12. By this means, control of the Vehicle/Appliance Actuators 7 can be transparently transferred to the operator of the Slave, or secondary, Transmitter 8 operator independent of transmission or signal encoding schemes employed by either the Master, or primary, Transmitter 1 or the Slave, or secondary, Transmitter 8.

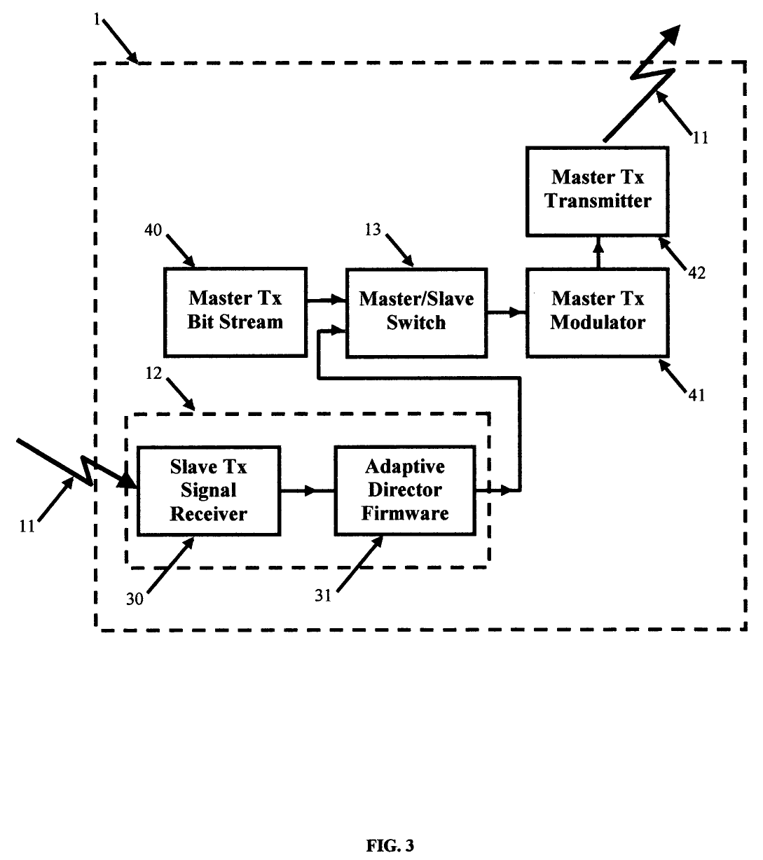

Referring now to FIG. 3 a high-level block diagram is shown of the operation of a Master, or primary, Transmitter 1 configured with a Slave Receiver and Adaptive Director Firmware Module 12 as illustrated in the representative embodiment of the present invention of FIG. 1. Slave, or secondary, Transmitter Signal Receiver 30 sub-module is receiving the Slave-to-Master Communications Link 11 signal. The Slave, or secondary, Transmitter Signal Receiver 30 sub-module demodulates the Communications Link 11 signal and passes the resultant Slave Bit Stream to the Adaptive Director Firmware 31. The Adaptive Director Firmware 31 performs all bit translations and modulation modifications indicated by the parameters stored in nonvolatile memory and/or attached switches/jumpers and submits the resultant bit stream to the Master/Slave Switch 13. The bit stream generated within the Master, or primary, Transmitter 1 is also submitted to the Master/Slave Switch 13 by Master Tx Bit Stream 40. When the Master/Slave Switch 13 is in the ‘Master’ position the bit stream from Master Tx Bit Stream 40 is directed to Master Tx Modulator 41 for propagation via the Master Tx Transmitter 42 over Primary Communications Link 4. When the Master/Slave Switch 13 is in the ‘Slave’ position the bit stream from the Adaptive Director Firmware 31 is directed to Master Tx Modulator 41 for propagation via the Master Tx Transmitter 42 over Primary Communications Link 4.

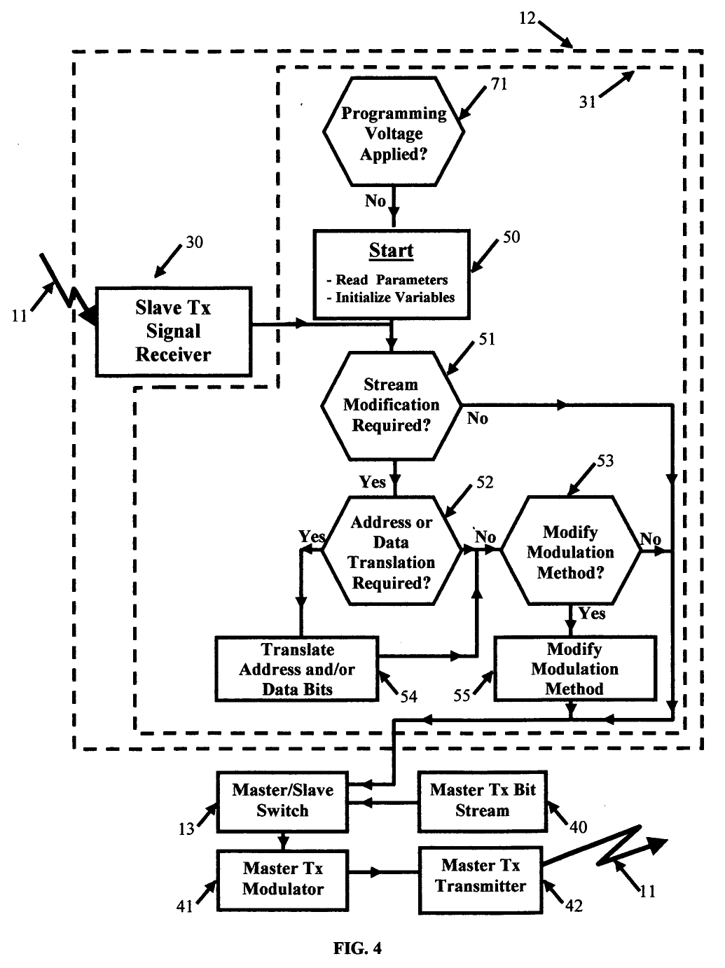

Referring now to FIG. 4 a programming flow chart for the Slave Receiver and Adaptive Director Firmware Module 12 for the representative embodiment of the present invention of FIG. 1 is illustrated. At initiation Query Programming Power 71 is executed and, as the programming power is not present, the Start 50 logic is invoked which accesses parameters stored in nonvolatile memory and/or attached switches/jumpers and initializes program variables. The stored parameters and attached switches/jumpers, if any, characterize the working environment including, but not limited to, method of bit stream encoding, number of channels, need and specifics for address and/or data translation of the ‘Slave’ bit stream, and need and specifics for modification of the modulation method.

Still referring to FIG. 4 the Slave, or secondary, Transmitter Signal Receiver 30 sub-module is receiving the incoming signal over the Slave-to-Master Communications Link 11, demodulates it and sends the ‘Slave’ data bit stream to Query Stream Modification Required 51. The receiver modules of certain remote devices currently in use discriminate among arriving signals by the contents of one or more fixed position bits in the signal stream. To accommodate these devices and maintain the desired selectivity, bit translation may be needed; if so it will be denoted by parameters stored within the Adaptive Director Firmware Module 31 and/or switches/jumpers attached to the Adaptive Director Firmware Module 31. If, using these stored parameters and/or attached switches/jumpers, Query Stream Modification Required 51 determines that either address or data stream bit translation is required Query Address or Data Translation Required 52 is called and it calls Translate Address and/or Data Bits 54 if analysis of the internal stored parameters and/or attached switches/jumpers so indicate; if not, processing continues with Query Modify Modulation Method 53. If called, Translate Address and/or Data Bits 54 performs the required bit stream translation and manipulation according to code installed in the program memory of the Adaptive Director Firmware 31 which interprets the internal stored parameters installed into the data memory of the Adaptive Director Firmware 31 and/or switches/jumpers attached to the Adaptive Director Firmware Module 31 and passes the modified stream to Query Modify Modulation Method 53. Various modulation methods are employed by existing remote control systems e.g. Pulse-Position-Modulation (‘PPM’) and Pulse-Code-Modulation (‘PCM’) and the modulation method of the Master, or primary, Transmitter 1 of FIG. 1 may be different from the modulation method of the Slave, or secondary, Transmitter 8 of FIG. 1. To accommodate these differences Query Modify Modulation Method 53 accesses internal stored parameters and/or attached switches/jumpers to determine if the modulation method of the Slave, or secondary, Transmitter 8 of FIG. 1 must be converted to the modulation method of the Master, or primary, Transmitter 1 of FIG. 1. If not, i.e. the modulation methods of both the Slave, or secondary, Transmitter 8 of FIG. 1 and the Master, or primary, Transmitter 1 of FIG. 1 are the same, no modification is needed and Query Modify Modulation Method 53 passes the bit stream directly to the Master/Slave Switch 13. If, on the other hand, Query Modify Modulation Method 53 determines that modulation method modification is required the bit stream is forwarded to Modify Modulation Method 55 to re-configure the bit stream to the correct modulation format according to code installed in the program memory of the Adaptive Director Firmware 31 which interprets the internal stored parameters installed into the data memory of the Adaptive Director Firmware 31 and/or switches/jumpers attached to the Adaptive Director Firmware Module 31. The bit stream then passes to the Master/Slave Switch 13. If the Master/Slave Switch 13 is in the ‘Slave’ position the Master/Slave Switch 13 connects the bit stream produced by the Adaptive Director Firmware 31 to the Master Tx Modulator 41 and finally to the Master Tx Transmitter 42 which propagates the stream over the Primary Communications Link 11. If, instead, the Master/Slave Switch 13 is in the ‘Master’ position the Master/Slave Switch 13 connects the Master Tx Bit Stream 40 to the Master Tx Modulator 41 and finally to the Master Tx Transmitter 42 which propagates the stream over the Primary Communications Link 11.

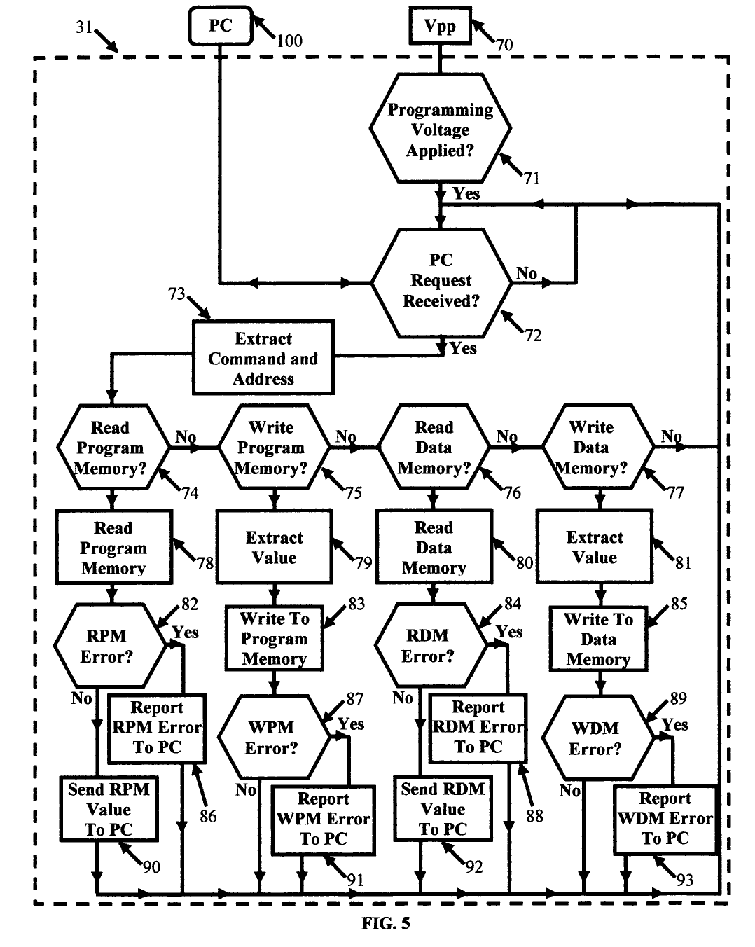

Referring now to FIG. 5 a generalized block diagram illustrating one method for how the Adapter Director Firmware of the wireless transferable control system of the present invention may be tailored to suit varying environments. At initiation Query Programming Power 71 is executed and, as the programming power is present, the programming mode of the Adaptive Director Firmware 31 sub-module is entered and Query PC Request Received 72 is called which retrieves a request string from Personal Computer 80 if one is available. The request string consists of a command value, an address value, and a data value. The Query PC Request Received 72 acknowledges the request causing Personal Computer 80 to enter a loop awaiting result notification from Adapter Director Firmware 31 sub-module. Extract Command and Address 73 copies the command and address values from the request string into local variables and calls Query Read Program Memory Command 74 which calls Execute Read Program Memory Command 78 if the command value, the command value copied into a local variable by Extract Command and Address 73, is a read program memory request. Execute Read Program Memory Command 78 issues a read program memory command at the designated address value, the address value copied into a local variable by Extract Command and Address 73, of the Adaptive Director Firmware 31 sub-module's program memory. Query Read Program Memory Error 82 sends the value read in a Read Program Memory Successful message to Personal Computer 80 via Send Read Program Memory Value To PC 90 completing the request if no error has occurred. If an unrecoverable read error has occurred Report Read Program Memory Error To PC 86 is called which completes the read program memory request by sending a Read Program Memory Error notification message to Personal Computer 80. If the command value, the command value copied into a local variable by Extract Command and Address 73, is not a read program memory Query Write Program Memory Command 75 is called and it calls Extract Value For Program Memory 79 if the command value, the command value copied into a local variable by Extract Command and Address 73, is a write program memory. Extract Value For Program Memory 79 extracts the data value from the request string and calls Execute Write Program Memory Command 83 which attempts to write the data value to the address value, the address value copied into a local variable by Extract Command and Address 73, of the Adaptive Director Firmware 31 sub-module's program memory, and calls Query Write Program Memory Error 87 to determine success or failure. If Execute Write Program Memory Command 83 completed without error Query Write Program Memory Error 87 sends a Request Successful notification message to Personal Computer 80. If unsuccessful, Report Write Program Memory Error To PC 91 is called which completes the write program memory request by sending a Write Program Memory Error notification message to Personal Computer 80. If the command value, the command value copied into a local variable by Extract Command and Address 73, is not a write program memory Query Write Program Memory Command 75 calls Query Read Data Memory Command 76 which calls Execute Read Data Memory Command 80 if the command value, the command value copied into a local variable by Extract Command and Address 73, is a read data memory request. Execute Read Data Command 80 issues a read data memory command at the designated address value of the Adaptive Director Firmware 31 sub-module's data memory. Query Read Data Memory Error 84 sends the value read in a Read Data Memory Successful message to Personal Computer 80 via Send Read Data Memory Value To PC 92 completing the request if no error has occurred. If an unrecoverable read error has occurred Report Read Data Memory Error To PC 88 is called which completes the read data memory request by sending a Read Data Memory Error notification message to Personal Computer 80. If the command value, the command value copied into a local variable by Extract Command and Address 73, is not a read data memory Query Write Data Memory Command 77 is called and it calls Extract Value For Data Memory 81 if the command value, the command value copied into a local variable by Extract Command and Address 73, is a write data memory. Extract Value For Data Memory 81 extracts the data value from the request string and calls Execute Write Data Memory Command 85 which attempts to write the data value to the address value, the address value copied into a local variable by Extract Command and Address 73, and calls Query Write Data Memory Error 89 to determine success or failure. If Execute Write Data Memory Command 85 completed without error Query Write Data Memory Error 89 sends a Request Successful notification message to Personal Computer 80. If unsuccessful, Report Write Data Memory Error To PC 93 is called which completes the write program memory request by sending a Write Program Memory Error notification message to Personal Computer 80. As documented and explained, the Adaptive Director Firmware 31 sub-module may be configured with programmable program memory and/or programmable data memory. The programmable data memory of the Adaptive Director Firmware 31 sub-module can by loaded by the means shown in FIG. 5, and described herein, with revisable parameters and, at execution time, these stored parameters can be accessed and, in conjunction with attached switches/jumpers that may also be provided, utilized by the logic coded and loaded into the program memory of the Adaptive Director Firmware 31 sub-module by the means shown in FIG. 5, and described herein, to enable the Wireless Transferable Control System of the present invention to provide the desired functionality with any combination of modulation scheme or bit protocol used by Master, or primary, Transmitters 1 and Slave, or secondary, Transmitters 8 of the representative embodiment of the present invention of FIG. 1 or any alternative embodiment of the present invention such as the alternative representative embodiment of the present invention of FIG. 2. This process applies equivalently and consistently to Adaptive Director Firmware of the present invention implemented as an integrated Slave Receiver and Adaptive Director Firmware Module or as implemented as a segmented Adaptive Director Firmware sub-module.

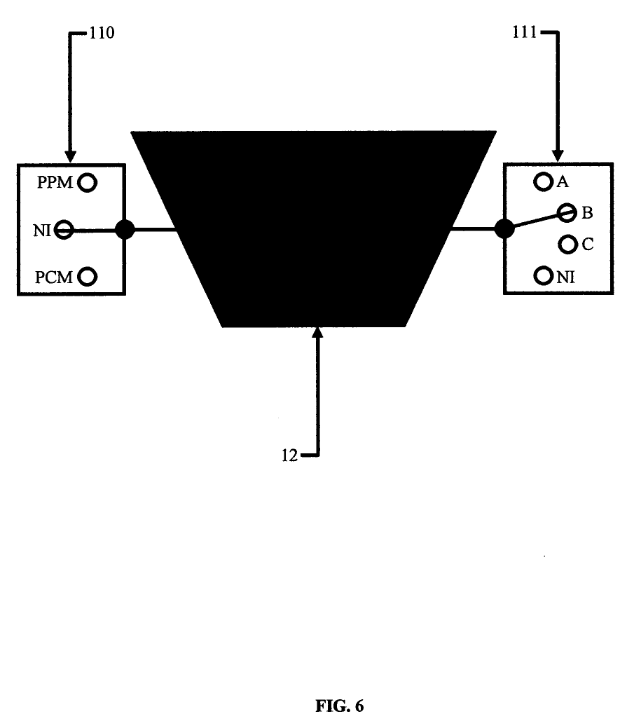

Referring now to FIG. 6 a second alternate embodiment of the present invention is illustrated showing how the Slave Receiver and Adaptive Director Firmware Module 12 of the wireless transferable control system of the present invention may be dynamically tailored to accommodate varying environments is illustrated. Various switches and/or jumpers may be connected, and their contact positions sensed by, the Slave Receiver and Adaptive Director Firmware Module 12. Instructions coded into the program memory of the Slave Receiver and Adaptive Director Firmware Module 12 can then utilize the acquired switch position information to selectively override the intent of parameters stored in the data memory of the Slave Receiver and Adaptive Director Firmware Module 12. In FIG. 6, Three Position Modulation Method Switch 110 is shown in the ‘NI’, or ‘No Impact’, position therefore the Modify Modulation Method parameters programmed into the internal data memory, if any, of the Slave Receiver and Adaptive Director Firmware Module 12 will be interpreted and processed by the logic programmed into the program memory of the Slave Receiver and Adaptive Director Firmware Module 12. If however, Three Position Modulation Method Switch 110 is set to the ‘PPM’ (Pulse Position Modulation) position the Modify Modulation Method parameters programmed into the internal data memory, if any, of the Slave Receiver and Adaptive Director Firmware Module 12 will be overridden causing the logic programmed into the program memory of the Slave Receiver and Adaptive Director Firmware Module 12 to Modify the Modulation Method to ‘PPM’ for the conditioned Slave Bit Stream accordingly. If Three Position Modulation Method Switch 110 is set to the ‘PCM’ (Pulse Code Modulation) position the Modify Modulation Method parameters programmed into the internal data memory, if any, of the Slave Receiver and Adaptive Director Firmware Module 12 will be overridden causing the logic programmed into the program memory of the Slave Receiver and Adaptive Director Firmware Module 12 to Modify the Modulation Method to ‘PCM’ for the conditioned Slave Bit Stream accordingly. Similarly, Four Position Channel Select Switch 111 will override any existing Address Translation parameters stored in the internal data memory of the Slave Receiver and Adaptive Director Firmware Module 12 unless set to the ‘NI’, or ‘No Impact’, position. A common Slave Bit Stream format assigns two specific bits to designate the channel for the stream; e.g. 00=Channel A, 01=Channel B, 10=Channel C. This scheme allows several transmitters of the same genre to operate concurrently without interfering one to the other as their associated remote receivers can discriminate among the multiple broadcasts based on the contents of the two channel bits and respond only to the bit stream of its channel. Thus, for instance, if Four Position Channel Select Switch 111 is set to the ‘A’ position this will override the Translate Address parameters programmed into the internal data memory, if any, of the Slave Receiver and Adaptive Director Firmware Module 12 and will cause the logic programmed into the program memory of the Slave Receiver and Adaptive Director Firmware Module 12 to modify the address bits of the Slave Bit Stream to designate Channel ‘A’. If Four Position Channel Select Switch 111 is set to the ‘B’ position this will override the Translate Address parameters programmed into the internal data memory, if any, of the Slave Receiver and Adaptive Director Firmware Module 12 and will cause the logic programmed into the program memory of the Slave Receiver and Adaptive Director Firmware Module 12 to modify the address bits of the Slave Bit Stream to designate Channel ‘B’. If Four Position Channel Select Switch 111 is set to the ‘C’ position this will override the Translate Address parameters programmed into the internal data memory, if any, of the Slave Receiver and Adaptive Director Firmware Module 12 and will cause the logic programmed into the program memory of the Slave Receiver and Adaptive Director Firmware Module 12 to modify the address bits of the Slave Bit Stream to designate Channel ‘C’. If Four Position Channel Select Switch 111 is set to the ‘NI’ position Translate Address parameters programmed into the internal data memory, if any, of the Slave Receiver and Adaptive Director Firmware Module 12 and will solely control weather or not the address bits of the Slave Bit Stream will be altered. Any and all parameters characterizing a bit stream can be controlled by programming the internal data memory and program memory of the Slave Receiver and Adaptive Director Firmware Module 12 of FIG. 6 for integrated unit implementations, or the Adaptive Director Firmware 31 sub-module of FIG. 3, for segmented implementations of the present invention and any and all can be dynamically overridden in field use by attaching to the Slave Receiver and Adaptive Director Firmware Module 12 of FIG. 6 for integrated unit implementations, or the Adaptive Director Firmware 31 sub-module of FIG. 3, for segmented implementations of the present invention corresponding switches and/or jumpers as exemplified by the Three Position Modulation Method Switch 110 and Four Position Channel Select Switch 111 examples of FIG. 6.

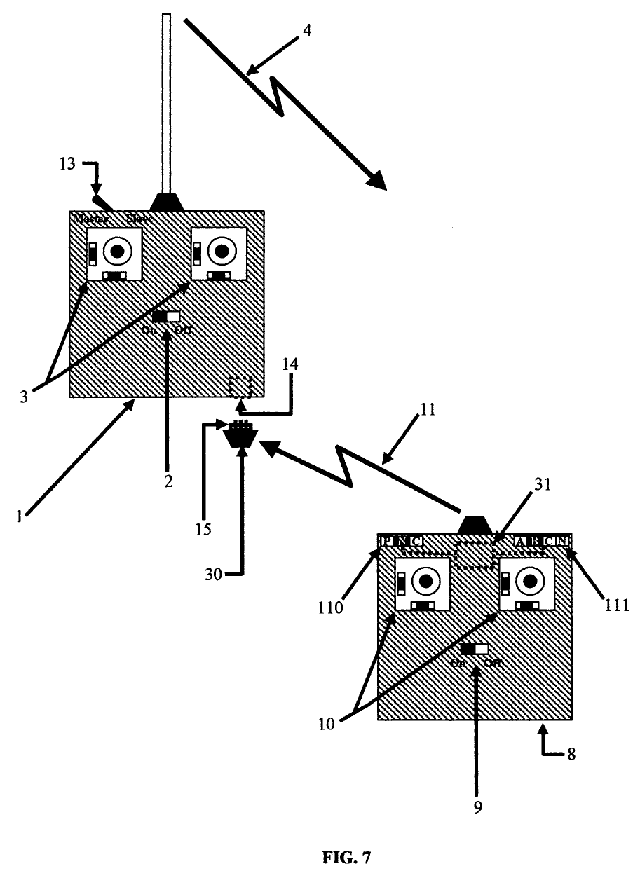

Referring now to FIG. 7 a front view of a third alternate embodiment of the present invention is illustrated having a Master, or primary, Transmitter 1, Master, or primary, Transmitter Power Switch 2, Master Control Sticks, Levers and Switches 3, a Primary Communications Link 4, a Slave, or secondary, Transmitter 8, a Slave, or secondary, Transmitter Power Switch 9, Slave Control Sticks, Levers and Switches 10, a Slave-To-Master Communications Link 11, a Master/Slave Switch 13, a Conventional ‘Buddy Box’ Socket Compatible Plug 15 affixed to the Slave, or secondary, Transmitter Signal Receiver 30 sub-module, an Adaptive Director Firmware 31 sub-module, a Three Position Modulation Method Switch 110, and a Four Position Channel Select Switch 111. Again in this embodiment the Master, or primary, Transmitter 1 is configured with a Conventional ‘Buddy Box’ Socket 14 used to plug in one end of the conventional Slave, or secondary, Transmitter to Master, or primary, Transmitter hard wired connection. In this third alternate embodiment of the present invention the Slave, or secondary, Transmitter Signal Receiver 30 sub-module and Adaptive Director Firmware 31 sub-modules of the Slave Receiver and Adaptive Director Firmware Module 12 of FIG. 1 are distributed and transposed and the Slave, or secondary, Transmitter Signal Receiver 30 sub-module is extended with a Conventional ‘Buddy Box’ Socket Compatible Plug 15. In this embodiment the conditioning of the Slave bit stream is performed by the Adaptive Director Firmware 31 sub-module that is integrated or attached to the Slave, or secondary, Transmitter 8. The Slave, or secondary, Transmitter 8 propagates the conditioned bit stream over the Slave-to-Master Communications Link 11 and the Slave, or secondary, Transmitter Signal Receiver 30 sub-module demodulates the signal it receives from the Slave-to-Master Communications Link 11. The output of the Slave, or secondary, Transmitter Signal Receiver 30 sub-module is connected to the ‘Slave’ terminal of the Master/Slave Switch 13 via the Conventional ‘Buddy Box’ Socket Compatible Plug 15 and Conventional ‘Buddy Box’ Socket 14. The processing and conditioning of the signal delivered to the Slave-to-Master Communications Link 11 by the Adaptive Director Firmware 31 sub-module is governed by logic embedded in the Adaptive Director Firmware 31 sub-module which conditions the Slave, or secondary, Transmitter 8 bit stream according to parameters also embedded within the Adaptive Director Firmware 31 and/or switches/jumpers attached to the Adaptive Director Firmware 31. Code installed into the program memory of the Adaptive Director Firmware 31 conditions the Slave, or secondary, Transmitter 8 bit according to interrogation and interpretation of parameters installed into the data memory of the Adaptive Director Firmware 31 and switches and/or jumpers connected to the Adaptive Director Firmware 31 sub-module. In this third alternate embodiment of the present invention illustrated in FIG. 7 dynamic modification switches Three Position Modulation Method Switch 110 and Four Position Channel Select Switch 111 are attached to the Slave, or secondary, Transmitter 8 and are connected to the Adaptive Director Firmware 31 sub-module embedded within Slave, or secondary, Transmitter 8. In FIG. 7, Three Position Modulation Method Switch 110 is shown in the ‘NI’, or ‘No Impact’, position therefore the Modify Modulation Method parameters programmed into the internal data memory, if any, of the Adaptive Director Firmware 31 sub-module will be interpreted and processed by the logic programmed into the program memory of the Adaptive Director Firmware 31 sub-module. If however, Three Position Modulation Method Switch 110 is set to the ‘PPM’ (Pulse Position Modulation) position the Modify Modulation Method parameters programmed into the internal data memory, if any, of the Adaptive Director Firmware 31 sub-module will be overridden causing the logic programmed into the program memory of the Adaptive Director Firmware 31 sub-module to Modify the Modulation Method to ‘PPM’ for the conditioned Slave Bit Stream. If Three Position Modulation Method Switch 110 is set to the ‘PCM’ (Pulse Code Modulation) position the Modify Modulation Method parameters programmed into the internal data memory, if any, of the Adaptive Director Firmware 31 sub-module will be overridden causing the logic programmed into the program memory of the Adaptive Director Firmware 31 sub-module to Modify the Modulation Method to ‘PCM’ for the conditioned Slave Bit Stream. Similarly, Four Position Channel Select Switch 111 will override any existing Address Translation parameters stored in the internal data memory of the Adaptive Director Firmware 31 sub-module unless set to the ‘NI’, or ‘No Impact’, position. If Four Position Channel Select Switch 111 is set to the ‘A’ position this will override the Translate Address parameters programmed into the internal data memory, if any, of the Adaptive Director Firmware 31 sub-module and will cause the logic programmed into the program memory of the Adaptive Director Firmware 31 sub-module to modify the address bits of the Slave Bit Stream to designate Channel ‘A’. If Four Position Channel Select Switch 111 is set to the ‘B’ position this will override the Translate Address parameters programmed into the internal data memory, if any, of the Adaptive Director Firmware 31 sub-module and will cause the logic programmed into the program memory of the Adaptive Director Firmware 31 sub-module to modify the address bits of the Slave Bit Stream to designate Channel ‘B’. If Four Position Channel Select Switch 111 is set to the ‘C’ position this will override the Translate Address parameters programmed into the internal data memory, if any, of the Adaptive Director Firmware 31 sub-module and will cause the logic programmed into the program memory of the Adaptive Director Firmware 31 sub-module to modify the address bits of the Slave Bit Stream to designate Channel ‘C’. If Four Position Channel Select Switch 111 is set to the ‘NI’ position Translate Address parameters programmed into the internal data memory, if any, of the Adaptive Director Firmware 31 sub-module and will solely control weather or not the address bits of the Slave Bit Stream will be altered and, if so, how they should be modified. Any and all parameters characterizing a bit stream can be controlled by programming the internal data memory and program memory of the Adaptive Director Firmware 31 sub-module of the present invention and any and all can be dynamically overridden in field use by attaching corresponding switches and/or jumpers as exemplified by the Three Position Modulation Method Switch 110 and Four Position Channel Select Switch 111 examples of FIG. 7. Thus a bit stream, originating in the Slave, or secondary, Transmitter 8, that is fully compatible with the modulation method and protocol of the Master Transmitter 1 can be generated and provided to the ‘Slave’ terminal of the Master/Slave Switch 13 via the Conventional ‘Buddy Box’ Socket Compatible Plug 15 and Conventional ‘Buddy Box’ Socket 14. By these means this third alternate embodiment of the present invention of FIG. 7 provides a wireless functionality equivalent to the conventional hard-wired system of instantiating transferable control of a remote vehicle or appliance independent of transmission or signal encoding schemes employed by either the Master, or primary, Transmitter 1 or the Slave, or secondary, Transmitter 8. The method and process for programming the program and/or data memory of the Adapter Director Firmware 31 sub-module illustrated in FIG. 5 and described above applies equivalently and consistently to this third alternate embodiment of the present invention of FIG. 7.

The construction details of the present invention are that the materials for the Slave Receiver and Adaptive Director Firmware Module 12 in a representative embodiment of the invention shown in FIG. 1, and for the Slave Receiver and Adaptive Director Firmware Module 12, Slave, or secondary, Transmitter Signal Receiver 30, Adaptive Director Firmware 31 shown in FIG. 3 and FIG. 4 and Adaptive Director Firmware 31 shown in FIG. 5, and for any alternative embodiment of the present invention such as the Slave Receiver and Adaptive Director Firmware Module 12 of the first alternate embodiment of the present invention shown in FIG. 2, and for and Adaptive Director Firmware Module 12 of the second alternate embodiment of the present invention shown in FIG. 6, and for the Slave, or secondary, Transmitter Signal Receiver 30 and Adaptive Director Firmware 31 shown in the third alternate embodiment of the present invention shown in FIG. 7 are standard electronic components including, but not limited to:
Resistors
Inductors
Capacitors
Transistors
Microprocessors
   implemented either as discrete devices or integrated clusters of devices, e.g. integrated circuits, or combinations of both in either leaded or surface mount packages. Construction may be accomplished by hand or automated assembly with interconnection via point-to-point wiring or printed circuit mounting and soldering or welding.

The size, shape, and pattern for the present invention for the Slave Receiver and Adaptive Director Firmware Module 12 in a representative embodiment of the invention shown in FIG. 1, and for the Slave Receiver and Adaptive Director Firmware Module 12, Slave, or secondary, Transmitter Signal Receiver 30, Adaptive Director Firmware 31 shown in FIG. 3 and FIG. 4 and Adaptive Director Firmware 31 shown in FIG. 5, and for any alternative embodiment of the present invention such as the Slave Receiver and Adaptive Director Firmware Module 12 of the first alternate embodiment of the present invention shown in FIG. 2, and for and Adaptive Director Firmware Module 12 of the second alternate embodiment of the present invention shown in FIG. 6, and for the Slave, or secondary, Transmitter Signal Receiver 30 and Adaptive Director Firmware 31 shown in the third alternate embodiment of the present invention shown in FIG. 7 is unrestricted and infinitely variable.

Although a few preferred embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention as claimed.

### ADVANTAGES OF THE PRESENT INVENTION

The advantages of the present invention include, without limitation, the great ease-of-use improvement of the Wireless Transferable Control System of the present invention in comparison to the cumbersome hard-wired transferable control system of the current art. Additionally, the unique programmability attributes of the Wireless Transferable Control System of the present invention provide compatibility among all Master, or primary, Transmitter and Slave, or secondary, Transmitters used for remote control—this functionality and flexibility is not available at all in the current art. The current art demands that the Master, or primary, and Slave, or secondary, Transmitters utilize similar bit stream format and modulation method and requires matching cable, plugs, and jacks. The programmability functionality of the present invention removes all of these restrictions allowing two or more similar or diverse transmitters to share, on-demand and as-desired, the control of remote devices and appliances independent of bit stream format or modulation method. The Wireless Transferable Control System of the present invention provides a quantum leap forward in flexibility, adaptability, and freedom of maneuverability for sharing remote controlled devices and appliances.

1. A Wireless Transferable Control System comprising a Slave Receiver and Adaptive Director Firmware Module, which may be instantiated as an integrated unit or segmented into a Slave, or secondary, Transmitter Signal Receiver sub-module and an Adaptive Director Firmware sub-module, for providing transferable control of remote devices and appliances.

2. The Wireless Transferable Control System of claim 1 wherein the Slave Receiver and Adaptive Director Firmware Module, for integrated implementations, or the Slave, or secondary, Transmitter Signal Receiver sub-module and the Adaptive Director Firmware sub-module for segmented implementations, of the present invention further provides a wireless facility for delivering the controls and commands of a Slave, or secondary transmitter, to a Master, or primary transmitter.

3. The Wireless Transferable Control System of claim 1 wherein the Slave Receiver and Adaptive Director Firmware Module, for integrated implementations, or the Slave, or secondary, Transmitter Signal Receiver sub-module and the Adaptive Director Firmware sub-module for segmented implementations, of the present invention further provides for the conversion of the bit stream of a Slave, or secondary transmitter, to the format required by a Master, or primary, transmitter.

4. The Wireless Transferable Control System of claim 1 wherein the Slave Receiver and Adaptive Director Firmware Module, for integrated implementations, or the Slave, or secondary, Transmitter Signal Receiver sub-module and the Adaptive Director Firmware sub-module for segmented implementations, of the present invention further provides for the conversion of the modulation method employed by a Slave, or secondary transmitter, to the modulation method required by a Master, or primary, transmitter.

5. The Wireless Transferable Control System of claim 1 wherein the contents of the programming memory and/or data memory of the Slave Receiver and Adaptive Director Firmware Module, for integrated implementations, or the Slave, or secondary, Transmitter Signal Receiver sub-module and the Adaptive Director Firmware sub-module for segmented implementations, of the present invention may be assembled on a separate computing system such as a personal computer and downloaded and installed into the Slave Receiver and Adaptive Director Firmware Module, for integrated implementations, or the Slave, or secondary, Transmitter Signal Receiver sub-module and the Adaptive Director Firmware sub-module for segmented implementations, to provide an infinitely variable compatibility capability among Master, or primary, Transmitters and Slave, or secondary, Transmitters for sharing the control of remote devices and appliances.

6. The Wireless Transferable Control System of claim 1 wherein the Slave Receiver and Adaptive Director Firmware Module, for integrated implementations, or the Slave, or secondary, Transmitter Signal Receiver sub-module and the Adaptive Director Firmware sub-module for segmented implementations, of the present invention further provides that the interpretation, by code installed into the program memory of the Slave Receiver and Adaptive Director Firmware Module, for integrated implementations, for integrated implementations, or the Slave, or secondary, Transmitter Signal Receiver sub-module and the Adaptive Director Firmware sub-module for segmented implementations, of any or all of the parameters installed into the data memory of the Slave Receiver and Adaptive Director Firmware Module, for integrated implementations, or the Slave, or secondary, Transmitter Signal Receiver sub-module and the Adaptive Director Firmware sub-module for segmented implementations, may be dynamically overridden by switches and/or jumpers connected to the Slave Receiver and Adaptive Director Firmware Module, for integrated implementations, or the Slave, or secondary, Transmitter Signal Receiver sub-module and the Adaptive Director Firmware sub-module for segmented implementations, when in service. When such switches and/or jumpers are present the code installed into the program memory of the Slave Receiver and Adaptive Director Firmware Module, for integrated implementations, or the Slave, or secondary, Transmitter Signal Receiver sub-module and the Adaptive Director Firmware sub-module for segmented implementations, of the present invention will condition the bit stream according to the contact settings of the connected switches and/or jumpers in addition to other, if any, non-overridden parameters installed into the data memory of the Slave Receiver and Adaptive Director Firmware Module, for integrated implementations, or the Slave, or secondary, Transmitter Signal Receiver sub-module and the Adaptive Director Firmware sub-module for segmented implementations.

7. The Wireless Transferable Control System of claim 1 wherein the Slave, or secondary, Transmitter Signal Receiver sub-module and the Adaptive Director Firmware sub-module for segmented implementations of the present invention further includes the capability to transpose the sequence of the Slave, or secondary, Transmitter bit stream flow between the Slave, or secondary, Transmitter Signal Receiver sub-module and the Adaptive Director Firmware sub-module in either order for segmented implementations consisting of a Slave, or secondary, Transmitter Signal Receiver sub-module and an Adaptive Director Firmware sub-module. The Slave, or secondary, Transmitter Signal Receiver sub-module and the Adaptive Director Firmware sub-module for segmented implementations of the present invention may be configured either with the Slave, or secondary, Transmitter bit stream flowing first to the Slave, or secondary, Transmitter Signal Receiver sub-module and subsequently to the Adaptive Director Firmware sub-module or with the Slave, or secondary, Transmitter bit stream flowing first to the Adaptive Director Firmware sub-module and subsequently to the Slave, or secondary, Transmitter Signal Receiver sub-module.

8. The Wireless Transferable Control System of claim 1 wherein the Slave, or secondary, Transmitter Signal Receiver sub-module and the Adaptive Director Firmware sub-module for segmented implementations of the present invention further includes the capability to distribute the Adaptive Director Firmware sub-module and the Slave, or secondary, Transmitter Signal Receiver sub-module of the Slave Receiver and Adaptive Director Firmware Module for segmented implementations consisting of a Slave, or secondary, Transmitter Signal Receiver sub-module and an Adaptive Director Firmware sub-module. The Slave, or secondary, Transmitter bit stream may flow by a wireless link from the Adaptive Director Firmware sub-module to the Slave, or secondary, Transmitter Signal Receiver sub-module for segmented implementations.
